(19) United States
(12) Patent Application Publication
(10) Pub. No.: US 2002/0029382 A1
(43) Pub. Date: Mar. 7, 2002

(54) Method of locking or unlocking a service on a digital receiver of audiovisual programs and device for implementing the method

(76) Inventors: Eric Deniau, La Baussaine (FR); Rene Gauthier, Arzon (FR); William Renault, Cesson-Sevigne (FR)

Correspondence Address: Joseph S. Tripoli, THOMSON multimedia Licensing, Inc., Two Independence Way, P.O. Box 5312, Princeton, NJ, 08543, US

(21) Appl. No.: 09/945,592

(22) Filed: Sep. 4, 2001

(30) Foreign Application Priority Data
Sep. 5, 2000 (FR) 0011264

(51) Int. Cl. H04N 7/16

(52) U.S. Cl. 725/25

(57) ABSTRACT

The present invention relates to a method of controlling access to audio-visual programs on a digital receiver of audio-visual programs, wherein it comprises, regardless of the program, a phase of locking the current program generated by an manual action during the current programme displaying. In this way, the user can, with the aid of a particularly simple command, lock or unlock the program currently being displayed.

The present invention also relates to the receiver implementing the method.

### FIELD OF THE INVENTION

The present invention relates to a simple method for locking/unlocking a program on a digital receiver of audiovisual programs, referred to hereinafter as a receiver. The invention also relates to a receiver of audiovisual programs implementing the method.

### BACKGROUND

U.S. Pat. No. 5,969,748 discloses a method of controlling access to television channels. Locking is performed from a list of accessible channels by selecting locking criteria. The criteria selectable from a list are schedule, topic, parental rating and/or channel. The system operates as follows. After having entered his password, the user enters on an interface a criterion from a list of criteria, for example a topic. All the programs of a list of channels encountering this topic are locked. When the user chooses to watch or record a locked program from the list of channels, a screen window appears inviting him to input his password. If the password input is correct, all the programs encountering the selected topic are unlocked. The problem with this method is that it operates only on the basis of a list of accessible channels. It therefore proves to be rather impractical according to this prior art to lock the program of the current channel, that is to say that to which the user is connected at a given moment, since this channel must previously have been tagged in a list of channels. Another problem is that it is impossible to lock a channel which is unknown a priori, that is to say which does not appear in the list of channels. The list of channels may in fact not be complete and the user may find himself faced with a channel discovered by chance and which it is impossible for him to lock. Moreover, when the user chooses to unlock the program, the mode of unlocking is unique.

The object of the present invention is therefore to alleviate the drawbacks of the prior art by proposing a method of locking a program on a digital decoder not requiring the presence of a list of accessible channels. The method in fact allows the user to lock the program to which the receiver is connected. The method according to the invention additionally makes it possible to unlock a program according to various modes. The invention will for example allow parental control.

### SUMMARY OF THE INVENTION

This aim is achieved by a method of controlling access to audio-visual programmes on a digital receiver of audio-visual programmes, wherein it comprises, regardless of the programme, a phase of locking the programme currently being displayed generated by an manual action during the current programme displaying.

According to another feature, the phase of locking a current program comprises:

a step of placing in memory at least one descriptor sent in the packets transmitted by the current program and identifying either the program, or a particular event of the program,

a step of activating the locking corresponding to the stored descriptor.

According to another feature, the locking is selected according to one of several modes such as:

temporary locking,

permanent locking,

event-based locking.

According to another feature, the unlocking is selected according to one of several modes such as:

temporary unlocking,

permanent unlocking,

event-based unlocking.

According to another feature, the temporary unlocking is eliminated by inhibiting or erasing the descriptor from the memory,

either following a step of detecting a change of channel,

or following a detection of a cycle of switching off and switching on the apparatus broadcasting the audiovisual programs.

According to another feature, the unlocking comprises the steps:

of displaying a screen window indicating that the chosen service is locked,

of triggering, by means, access to the process for unlocking the service,

of displaying a screen window suggesting entry of the user code or exit from the unlocking procedure,

of comparing the entered code with a stored code,

of displaying a screen window suggesting various modes of unlocking, if the code entered is correct,

of selecting a mode of unlocking,

of unlocking the service according to the mode chosen, or

of displaying a screen window suggesting that the user code be re-entered or that the procedure for unlocking the service be exited, if the code entered is incorrect.

According to another feature, failing selection, the unlocking is temporary.

According to another feature, the re-locking of a service unlocked in a temporary manner is automatic.

According to another feature, the event-based mode of unlocking relates to the next event or to several consecutive events thereof during which the operator performs the unlocking.

According to another feature, the locking comprises the steps:

of accessing the process for locking the program,

of displaying a screen window prompting the user to enter a user code or to exit the locking procedure,

of displaying a screen window signaling that the service is locked, if the user code entered is correct, or

of displaying a screen window suggesting that the user code be re-entered or that the locking procedure be exited, if the user code entered is incorrect.

According to another feature, the locking can be performed from a list of user-accessible programs.

According to another feature, the method comprises a step of storing the descriptor of the current event when the mode of unlocking is event-based and a step of detecting, by the microprocessor, the change of descriptor of the event so as to perform the event-based unlocking and allow the decoding of the event.

Another aim of the invention is to propose a device implementing this method.

This other aim is achieved by a digital receiver for controlling access to audio-visual programmes comprising a user interface with the receiver, this interface comprising means for triggering locking of the programme currently being displayed activated by an manual action during the current programme displaying, means for selecting via the user interface one of several modes of locking and means of reaction of the receiver ensuring the recording of the information required for implementing the chosen locking.

According to another feature, the means of triggering of the user interface comprise at least one button making it possible to access the locking or unlocking process.

According to another feature, the means of reaction comprise means for storing the information associating a program with a mode of locking or of unlocking of the receiver.

According to another feature, the means of reaction comprise means of detecting an event of the stored program, of triggering the unlocking of the decoder during the event and of causing locking upon detection of the end of the event.

### BRIEF DESCRIPTION OF THE DRAWINGS

The invention, together with its characteristics and advantages, will emerge more clearly from reading the description given with reference to the appended drawings in which:

FIG. 1 represents the operating diagram of a DVB (Digital Video Broadcast) decoder,

FIG. 2 represents in plan view a remote control used for the decoder,

FIGS. 3 to 7 represent the monitor keyed with various screens at various steps of the method,

FIG. 8 represents a flowchart of the locking procedure,

FIG. 9 represents a flowchart of the unlocking procedure.

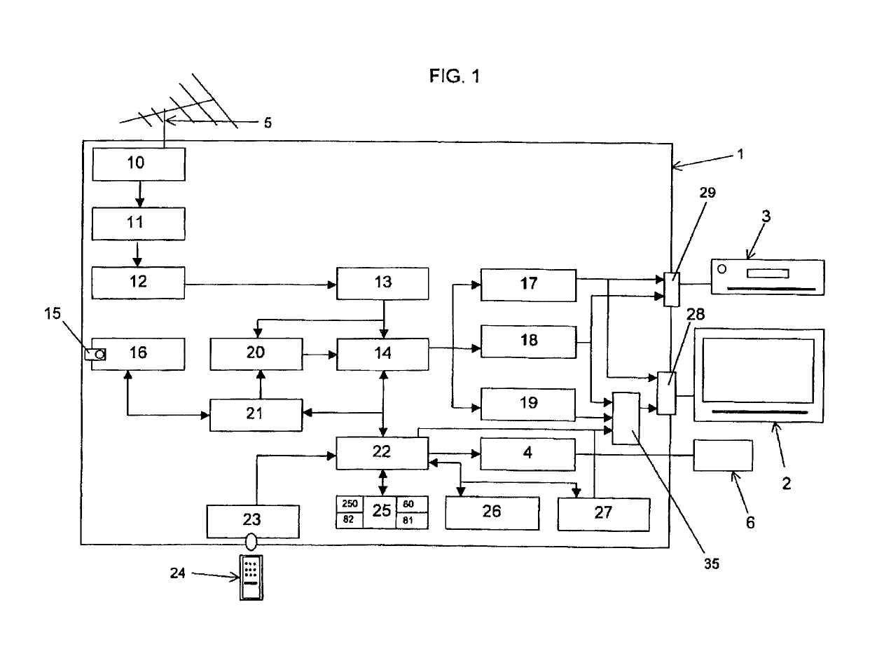

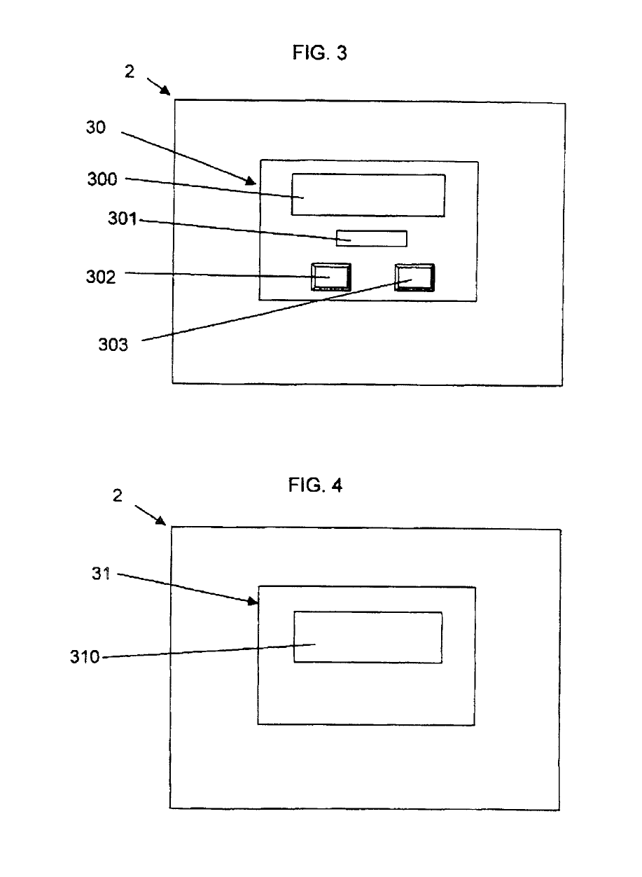

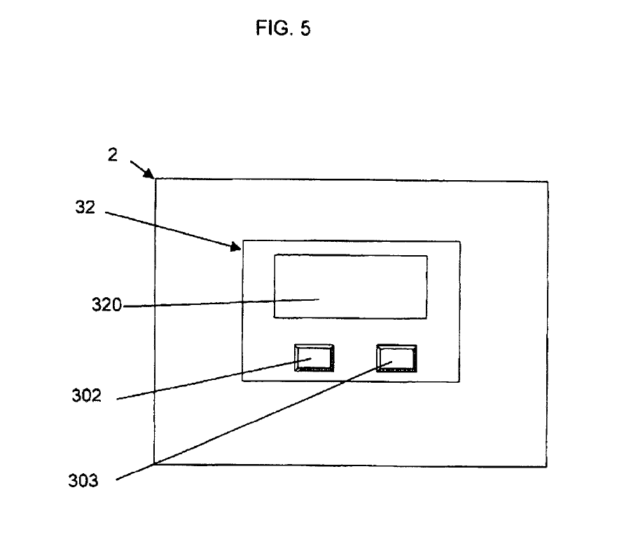

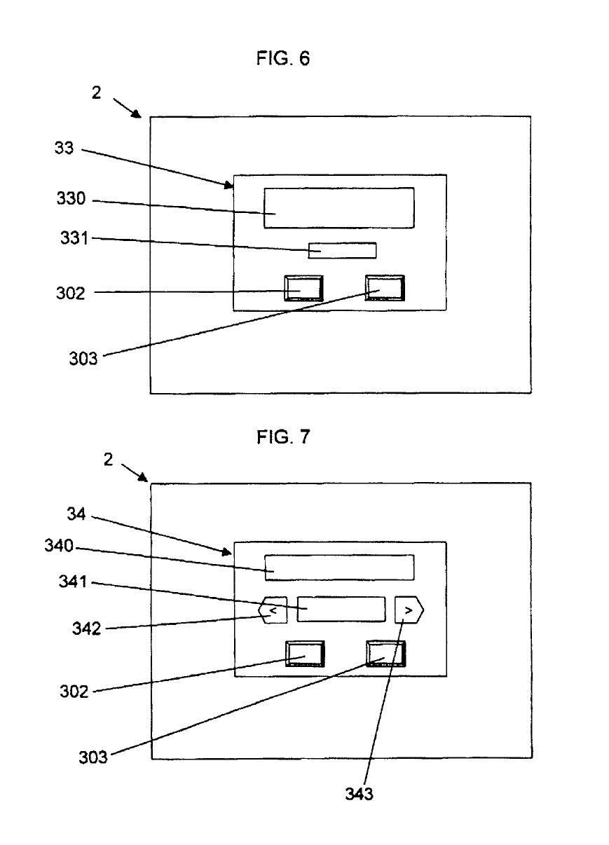

The invention will be described in conjunction with FIGS. 1 to 9.

### DETAILED DESCRIPTION

The invention relates to a method of locking/unlocking a program on any type of digital receiver of audiovisual programs, such as a decoder (1). Digital decoders (1) are for example of the following types: DVB (Digital Video Broadcast), DSS (Digital Satellite System) or any type of Internet terminal. In all types of digital decoder (1), there is a means for identifying a program broadcast on a channel in a unique manner. In DVB, it is a triple identifying the program. This triple is composed of three identifiers (“network” ID, “transport stream” ID and “service” ID), one relating to the network, a second, the transport stream, and a third, the service. When it has not been previously stored by the software, the triple identifying the current program can be retrieved, in the case of a DVB decoder, by combining the information found in the PMT table (in which the service ID appears) and “SDT actual” table (in which the original “network ID” and “transport stream ID” data appear. In the case of an Internet terminal, this information will be replaced with the complete name of the current URL which is stored in the search, display and edit utility (otherwise known as the “browser”) and which identifies a program, in the form of a character string.

A DVB digital decoder used within the framework of our invention is made up as follows.

The decoder is connected to a television (2) through a “SCART” socket (28), to a video recorder (3) also through a “SCART” socket (29) and to the switched telephone network (6) through a modem (4).

The decoder (1) comprises a tuner (10) linked to a frequency converter of an antenna (5). The tuner (10) is connected to an error correction circuit (12) through a demodulator (11). The output of the error correction circuit (12) is linked to a demultiplexer (13). This demultiplexer (13) separates the various data packets according to their content and sends them to the relevant items through a buffer memory (14). The relevant items include among others an access control module comprising a chip card (15) inserted into a connector (16), an audio decoder (17), a video decoder (18) and a teletext management circuit (19).

The access control module also comprises a descrambler (20), through which any encrypted packet must pass before being stored in the buffer memory (14). The descrambler (20) is managed by a verifier circuit (21), which authorizes or otherwise the descrambling as a function of the user's access rights.

The decoder also comprises a microprocessor (22) linked to an infrared interface (23) capable of receiving signals from a remote control (24). The microprocessor (22) is moreover linked to a memory (25) storing the triples identifying each program. The memory (25) comprises a program (80) for locking a program, a program (81) for unlocking a program as well as a table (82).

The microprocessor (22) reads the demultiplexed data of the program from the buffer memory (14). These data of the channel correspond to information about each event broadcast by the program. This information may be the name of the event, the parental rating, etc.

The signals originating from the video decoder (18), from the audio decoder (17) and from the microprocessor (22) are sent to a mixer circuit (35), connected to the SCART socket (28) linking the decoder (1) to the television (2). This mixer (35) also receives signals from a video keying circuit (27), this circuit receiving signals formulated by the microprocessor from a software layer (26) for managing the infrared signals of the interface (23).

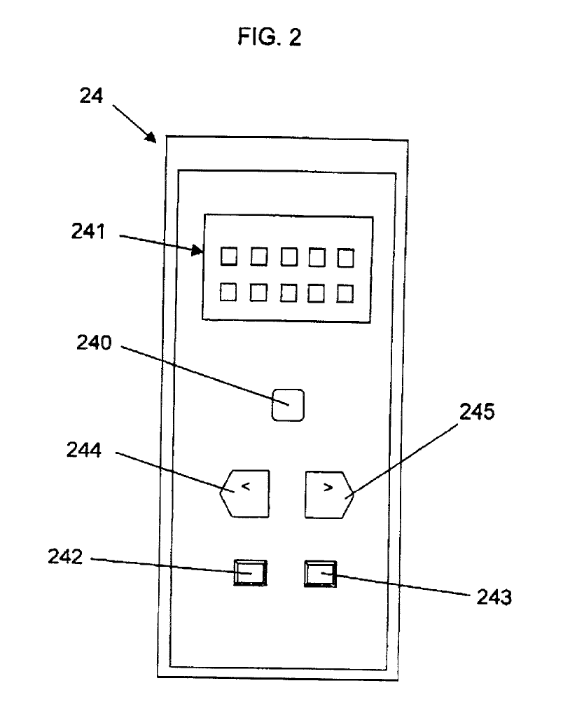

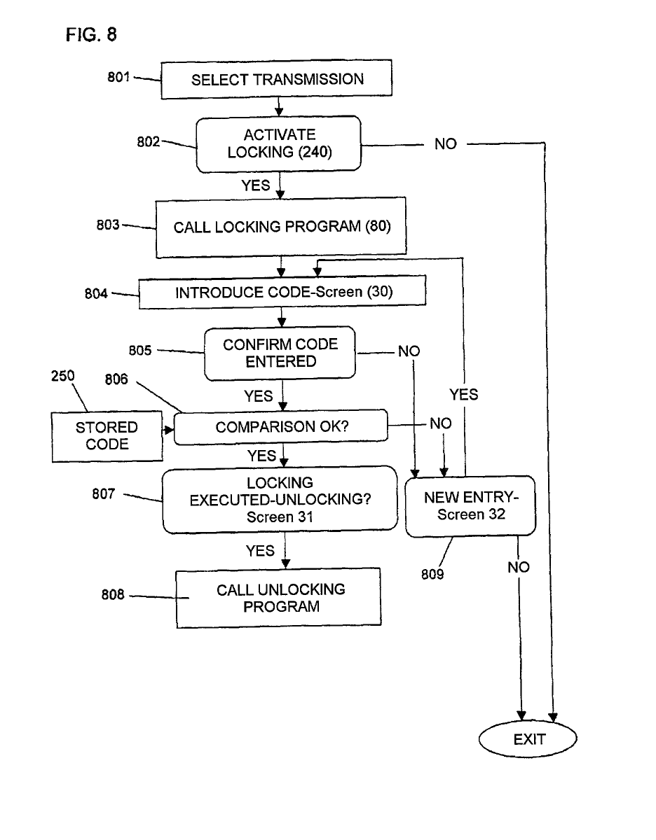

All the manipulations will for example be performed from a remote control (24) illustrated in FIG. 2. The user connects up to the program which he wants to lock, as represented in step (801) of FIG. 8. He presses a button of the remote control, indicating that he wants to lock the program to which he is connected, as represented in step (802) of FIG. 8. This button may for example bear the name “lock/unlock” (240). Actuation of this button (240) causes the program of a specific signal by the remote control (24). The specific signal, received by the infrared interface (23), triggers the processing, by the microprocessor (22), of a specific subroutine (80) stored in the memory (25) associated with the microprocessor (22) and calling the locking process, as represented in step (803) of FIG. 8. This specific program (80) causes the displaying on the television (2) of a screen window (30) for entering a code, as represented in step (804) of FIG. 8. This code may for example be identical to a code already present in the decoder (1). This code should not be known to persons for whom the program is locked, children for example, since it makes it possible to access the locking or the unlocking of a program. The code is entered by the user from a digital keypad (241) on the remote control (24). The entry screen window (30) is made up of an indication (300) indicating to the user that he has just accessed the process for locking a program, while inviting him to input his code. This screen window (30) also displays a zone (301) provided for the displaying of the entry of the code, for example in the form of asterisks so as to prevent the code from being revealed to an onlooker, and two keys (302, 303) corresponding to buttons of the remote control (24). One button, for example “OK” (242), is intended for confirming entry of the code, the other button, for example “EXIT” (243), for exiting the locking process. If the user confirms his code, as represented in step (805) of FIG. 8, the specific subroutine (80), executed by the microprocessor (22), compares the code entered with the code (250) stored in the memory (25), as represented in step (806) of FIG. 8, and if the code entered is correct, the program is then locked as represented in step (807). The specific subroutine (80), executed by the microprocessor (22), allows the sending of the information required for the displaying of a screen window (31) which then appears, while indicating the locking of the program and while inviting the user by pressing the “lock/unlock” button (240) of the remote control (24) to access the process for unlocking the program, as represented in step (807) of FIG. 8. The user may therefore activate the unlocking program, as represented in step (808) of FIG. 8. If the user confirms his code and if the code entered is incorrect, the specific subroutine (80), executed by the microprocessor (22), compares the code entered with the code (250) stored in the memory (25), as represented in step (806) of FIG. 8, and sends the information so as to display a screen window (32), indicating that his code is incorrect. The screen window (32) also invites the user, through a message (320), to recommence entry of the code by pressing the “OK” button (242), that is to say to return to step (804) or to exit the locking process by pressing the “EXIT” button (243), as represented in step (809) of FIG. 8. The image of a locked program is not displayed on the screen of the television (2), the device displays for example only the fact that the program is locked.

According to a variant embodiment, an event of a current program or a current program is locked following a single press of the “lock/unlock” button (240) of the remote control (24). No code entry is required at the moment of the locking of the event or of the channel. On the other hand, unlocking will require the entry of a code stored previously, for example when initially commissioning the decoder, with the aid of a menu (not illustrated). This variant allows instantaneous locking from a single button, this being especially beneficial when the viewer is distracted by a telephone call, a visitor or some other urgent situation.

The unlocking according to the method occurs as follows.

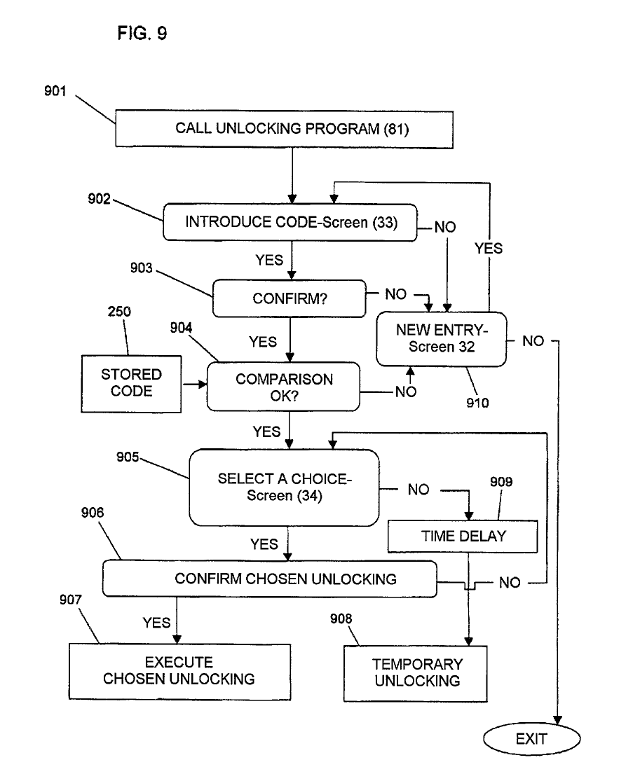

When the user seeks to connect up to a locked program, the program for using the decoder examines the table (82) of locked programs in the memory (25) and invites the user to unlock by way of the screen window (31), as represented in step (807) of FIG. 8. The decoding of the program is executed if the latter is not locked. This screen window (31) invites the user, via a message (310), to press the “lock/unlock” button (240) so as to access the process for unlocking the locked program which he wants to display. After pressing this button (240), the specific signal, received by the infrared interface (23), triggers the processing, by the microprocessor (22), of a specific subroutine (81) stored in the memory (25) associated with the microprocessor (22) and calling the unlocking process, as represented in step (901) of FIG. 9. A new screen window (33) then appears. This screen window (33) is made up of a text zone (330), indicating that the user has just entered the process for unlocking the program and inviting him to input his code, as represented in step (902) of FIG. 9. This code is the same as the one used for locking a program. The user enters his code with the aid of the keypad (241) of the remote control (24). This entry is manifested by the displaying of asterisks in the zone (331) of the screen window (33). The user confirms his code by virtue of the “OK” button (242) or prefers to exit the unlocking process via the “EXIT” button (243). In the latter case, the program then remains locked. After confirming the code, as represented in step (903) of FIG. 9, the specific subroutine (81) executed by the microprocessor (22) compares the code entered with the code (250) stored in the memory (25), as represented in step (904) of FIG. 9, and if the code entered is correct, sends the information so as to display a new screen window (34), as represented in step (905) of FIG. 9. This screen window (34) allows the user to select a particular mode of unlocking for the locked program to which he is connected. To do this, the screen window (34) is made up of a text zone (340) reminding the user that he is in an unlocking process, of two keys (302, 303), corresponding to the “OK” button (242) and “EXIT” button (243) of the remote control (34), respectively for confirming and exiting the process and of a zone (341) for selection of the mode of unlocking. This selection is made by pressing two shift buttons “<” (244) and “>” (245) of the remote control (24). These shift buttons (244, 245), symbolized on the screen window (34), on either side of the text zone (341) presenting the mode of unlocking, through two keys “<” (342) and “>” (343), allow scrolling of the modes of unlocking the program. The use of the shift buttons (244, 245) allows the display of various unlocking menus provided, corresponding to the following three modes: temporary unlocking, permanent unlocking or event-based unlocking. By acting on the shift arrows (244, 245) of the remote control (24), the user selects one of these modes, then confirms his choice by pressing the “OK” button (242) on his remote control (24), as represented in step (906) of FIG. 9. The program is then unlocked according to the mode chosen, as represented in step (907) of FIG. 9. The user can at any moment choose to leave the unlocking process by pressing the “EXIT” button (243). If, after comparison in step (904), the code entered is incorrect, the specific subroutine executed by the microprocessor sends the information so as to display a screen window (32) indicating that the code entered is incorrect. The window also invites the user in a step (910) to re-enter his code by pressing the “OK” button (242), that is to say to return to step (902) or to exit the unlocking process by pressing the “EXIT” button (243).

Failing selection with the aid of the scroll buttons (244, 245), the mode of unlocking after a certain time delay (909) is fixed at “temporary” by the program (81), as represented in step (908) of FIG. 9.

Temporary unlocking of the program signifies that if the user leaves the program which he has just unlocked in order to connect up to, for example, another program and should the user return to the program that he had unlocked, this program will again be locked. The user will therefore have to instigate a new unlocking process if he wishes to have access thereto. This mode allows the user who unlocks a program not to have to worry about locking the program when he leaves it.

Permanent unlocking of the program signifies that if the user leaves the program for, for example, another program and should he return to the initial program, the latter will still be unlocked. This allows the user to unlock a program for which he estimates that an inaccessibility is no longer necessary.

Event-based unlocking signifies that the user unlocks the program for the time corresponding to the remaining duration of the event in progress. After the event-based unlocking of the program, when the event has terminated, the program is locked again.

It is possible to extend event-based unlocking to the event following the event in progress or even to several consecutive events. In this case the program (81) performs the reading of the code identifying the event and those following it, and interrupts the program when the latter no longer corresponds to the event or to the event sequence chosen.

In a process for locking a program, the memory (25) stores the triple identifying the program. Through the use of a so-called MMI software layer (26), the microprocessor (22) prohibits connection to the desired program, that is to say does not open the video and audio streams. Thereafter, through the use of this software layer (26), the microprocessor acts on the video keying circuit (27) which will manage the display of the screen window (31) on the television (2) indicating that the program is locked. At each change of program, the microprocessor (22) scans the memory (25) so as to ascertain whether the triple identifying the current program which the user has selected is contained in the table (82). If the triple is stored in the table (82) of the memory (25), the microprocessor (22), through the software layer (26), disables the video and audio connection, and then acts on the video keying circuit (27) which will then take charge of the display of the locking messages. The video keying circuit (27) also takes charge of showing all the screen windows for entry, unlocking, etc.

When the unlocking of the program is temporary, the microprocessor (22) authorizes the mixer (35) to send the information to the television (2). The program is automatically re-locked after a change of program.

When the unlocking of the program is permanent, the triple is removed from the memory (25) without being reincorporated, except in the case of a new locking of the program.

When the unlocking relates to a particular event of a program, the memory (25) will store an information cue relating to the event in progress for which the user wishes that the program be unlocked. This information cue is stored among other information cues about the event in the buffer memory (14). This information cue is for example the identifier of the event in progress of a given program and has the name “event ID”. This “event ID” identifier is extracted from the information broadcast in the “EIT present/following” table of the current event. During a subsequent selection of the event by a user, a comparison is made between the “event ID” identifier of the event selected and the “event ID” identifier stored. If these values are equal, the program remains unlocked, the unlocked event has not in fact terminated. If these values are different, the program is re-locked automatically since the event for which the program has been unlocked has terminated. In the latter case, the “EIT present/following” table has altered or, stated otherwise, its version number has been incremented.

When the user performs an event-based unlocking, the microprocessor (22) receives, from the other items, the signal for detecting a change of event. The microprocessor (22) then acts on the software layer (26) so as to re-lock the program. It is also possible to unlock the following event or even several consecutive events.

It is possible to imagine selection of a mode of locking. The locking could be temporary, permanent or event-based. The locking procedure would then be the same as the unlocking procedure presented above. In the case where event-based locking is desired, the “event ID” identifier of the event in progress of a program is taken out of the “EIT present/following” table and stored in the memory (25). This event may already form the subject of a locking, for example temporary or permanent, of the program on which it is broadcast. During event-based locking, the “event ID” identifier of the current event is compared with the “event ID” identifier stored. If their values are equal, this signifies that the event for which the program is locked has not terminated, the program then remains locked. On the other hand, if their values are different, this signifies that the event has changed and the program unlocks automatically.

It should be obvious to persons versed in the art that the present invention allows embodiments in numerous other specific forms without straying from the field of application of the invention as claimed. Consequently, the present embodiments must be regarded by way of illustration, but may be modified within the field defined by the scope of the attached claims, and the invention should not be limited to the details given herein above.

1. Method of controlling access to audio-visual programmes on a digital receiver of audio-visual programmes, wherein it comprises, regardless of the programme, a phase of locking the programme currently being displayed generated by an manual action during the current programme displaying.

2. Method of controlling access according to claim 1, wherein the phase of locking a current programme comprises:
a step of placing in memory at least one descriptor sent in the packets transmitted by the current programme and identifying either the programme, or a particular event of the programme,
a step of activating the locking corresponding to the stored descriptor.

3. Method of controlling access according to claim 1, wherein the locking is selected according to one of several modes such as:
temporary locking,
permanent locking,
event-based locking.

4. Method of controlling access according to claim 1, wherein it comprises a phase of unlocking being selected according to one of several modes such as:
temporary unlocking,
permanent unlocking,
event-based unlocking.

5. Method of controlling access according to claim 4, wherein the temporary unlocking is eliminated by inhibiting or erasing the descriptor from the memory,
either following a step of detecting a change of channel,
or following a detection of a cycle of switching off and switching on the apparatus broadcasting the audio-visual programmes;
said descriptor identifying the service unlocked.

6. Method of controlling access according to claim 1, wherein it comprises a phase of unlocking comprising the steps:
of displaying a screen window indicating that the chosen service is locked,
of triggering, by means, access to the process for unlocking the service,
of displaying a screen window suggesting entry of the user code or exit from the unlocking procedure,
of comparing the entered code with a stored code,
of displaying a screen window suggesting various modes of unlocking, if the code entered is correct,
of selecting a mode of unlocking,
of unlocking the service according to the mode chosen, or
of displaying a screen window suggesting that the user code be re-entered or that the procedure for unlocking the service be exited, if the code entered is incorrect.

7. Method of controlling access according to claim 6, wherein, failing selection, the unlocking is temporary.

8. Method of controlling access according to claim 4, wherein the re-locking of a service unlocked in a temporary manner is automatic.

9. Method of controlling access according to claim 4, wherein the event-based mode of unlocking relates to the next event or to several consecutive events thereof during which the operator performs the unlocking.

10. Method of controlling access according to claim 1, wherein the locking comprises the steps:
of accessing the process for locking the programme,
of displaying a screen window prompting the user to enter a user code or to exit the locking procedure,
of displaying a screen window signalling that the service is locked, if the user code entered is correct, or
of displaying a screen window suggesting that the user code be re-entered or that the locking procedure be exited, if the user code entered is incorrect.

11. Method of controlling access according to claim 10, wherein the locking can be performed from a list of user-accessible programmes.

12. Method of controlling access according to claim 2, wherein it comprises a step of storing the descriptor of the current event when the mode of unlocking is event-based and a step of detecting, by the microprocessor, the change of descriptor of the event so as to perform the event-based unlocking and allow the decoding of the event.

13. Digital receiver for controlling access to audio-visual programmes comprising a user interface with the receiver, this interface comprising means for triggering locking of the programme currently being displayed activated by an manual action during the current programme displaying, means for selecting via the user interface one of several modes of locking and means of reaction of the receiver ensuring the recording of the information required for implementing the chosen locking.

14. Digital receiver for controlling access to audio-visual programmes according to claim 13, wherein the means of triggering of the user interface comprise at least one button making it possible to access the locking or unlocking process.

15. Digital receiver for controlling access to audio-visual programmes according to claim 13, wherein the means of reaction comprise means for storing the information associating a programme with a mode of locking or of unlocking of the receiver.

16. Digital receiver for controlling access to audio-visual programmes according to claim 13, wherein the means of reaction comprise means of detecting an event of the stored programme, of triggering the unlocking of the decoder during the event and of causing locking upon detection of the end of the event.
